(19) United States
(12) Patent Application Publication
(10) Pub. No.: US 2007/0008166 A1
(43) Pub. Date: Jan. 11, 2007

(54) Device for acquiring and monitoring the developement of a product-related variable, and product monitoring system comprising such a device

(75) Inventors: Christian Kovacik, Moissy Cramayel (FR); Marc Battyani, Hericy (FR)

Correspondence Address: BUCHANAN, INGERSOLL & ROONEY PC, POST OFFICE BOX 1404, ALEXANDRIA, VA, 22313-1404, US

(73) Assignee: KBS, Moissy Cedex (FR)

(21) Appl. No.: 10/560,820

(22) PCT Filed: Jun. 16, 2004
(86) PCT No.: PCT/FR04/01495

§ 371 Date: May 16, 2006

(30) Foreign Application Priority Data
Jun. 16, 2003 (FR) 03/07227

(51) Int. Cl. G08B 5/22

(52) U.S. Cl. 340/815.45

(57) ABSTRACT

Disclosed is a device for acquiring and monitoring over time the development of at least one product-related variable. Said device comprises a support (34) that is associated with the product and supports a set of at least one sensor (26) for measuring said variable and means (30, 32, 34) for processing the data output by the sensor so as to monitor the development of said variable relative to threshold values. Said processing means are provided with a file system (30) in which the data output by the sensor is stored and a management algorithm (32) that organizes storing of the data in the file system and manages retrieval of said data. The file system and the management algorithm are mounted within the support.

The present invention relates, generally, to the acquisition and monitoring of product-related variables. More particularly, the invention relates to the monitoring over time of the development of at least one product-related variable in order to check its state or integrity.

The invention applies in particular to the prevention of degradation of a perishable product or the prevention of its contamination. Thus, a particularly interesting application of the invention concerns checking the temperature of a bag of blood between a blood-taking phase and a transfusion phase. It will be understood, however, that the invention applies equally to all types of perishable products or commodities, such as foodstuffs or medications for which the transport conditions must be accurately observed in order to avoid any risk of degradation.

Conventionally, the transportation of a perishable product is observed, for example, using temperature sensors which change color irreversibly if the temperature of the product exceeds a threshold value corresponding to a maximum value allowed for the product.

It has also been proposed to use measurement sensors associated with storage means into which is loaded data output by the sensors. Duly programmed computation means process the data output by the sensors to generate an alert signal if the threshold value is exceeded, however temporarily.

This type of device provides a relatively effective traceability of a product inasmuch as it can be used to effectively observe any overrun of a monitored variable.

It does, however, present a major drawback inasmuch as the quantity of the data stored is directly linked to the capacity of the memory, such that it is not possible to monitor a product for relatively long periods or simultaneously monitor a number of variables without prohibitively increasing the capacity of the memory and therefore the size of said device.

The object of the invention is therefore to overcome the drawbacks of the state of the art.

Its subject is therefore a device for acquiring and monitoring over time the development of at least one product-related variable, including a support intended to be associated with the product and supporting a set of at least one sensor for measuring said variable and means for processing the data output by the sensor so as to monitor the development of said variable relative to threshold values.

According to a general characteristic of the device according to the invention, the processing means include a file system in which the data output by the sensor is stored and a management algorithm for organizing the storing of the data in the file system and managing the retrieval of said data, the file system and the management algorithm being embedded in the support.

The use of an embedded management algorithm makes it possible to organize the storing of the stored data and so increase the volume of information stored without providing a specific format for the stored data, the storing then being done in a manner similar to data storage in a computer hard disk.

According to another characteristic of the device according to the invention, the latter also includes a universal internal clock, the processing means monitoring the development over time of said variable according to timetable data supplied by the clock.

Advantageously, the processing means also include means for creating product monitoring phases, each corresponding to a state of the product, by assigning specific threshold and duration values to each phase.

Preferably, the device is provided with a display unit for indicating any overrun of the threshold value(s). This display unit can be a blinking indicator, the color of which reflects a criterion for acceptance of a signaled overrun. For example, the blinking indicator comprises a light-emitting diode.

According to another characteristic of the invention, the device includes an independent power supply battery. Advantageously, voltage step-up means are used for powering the light-emitting diode from the power supply battery.

Furthermore, the device includes means for transferring the stored data to a remote product monitoring system, in response to a request to transfer said data sent by said system.

Advantageously, the transfer means are wireless data transfer means.

In a particular embodiment, the support also includes means of encoding information by barcodes.

According to the invention, there is also proposed a system for monitoring products by observing the development over time of at least one product-related variable, including a set of sensors for measuring said variable and a remote monitoring center for displaying the data output by the sensors.

The sensors consist of devices as defined above.

According to a characteristic of this system, the remote monitoring center is connected to a computer network, in particular the Internet.

Other objects, characteristics and advantages of the invention will become apparent from reading the description that follows, given solely by way of nonlimiting example, and with reference to the appended figures, in which:

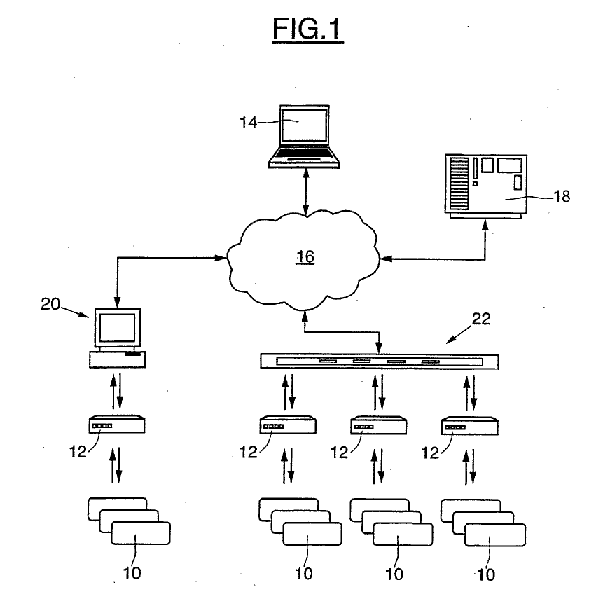

FIG. 1 is a general schematic view of a product monitoring system according to the invention;

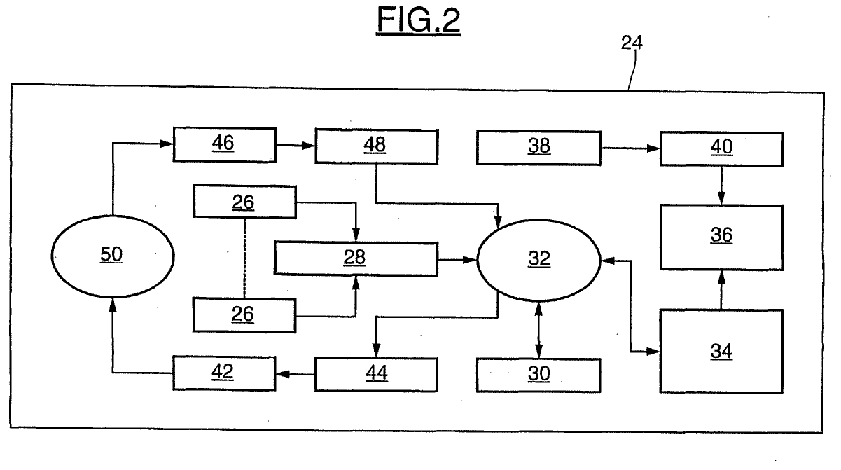

FIG. 2 is a block diagram illustrating the structure of a measurement sensor of the system of FIG. 1; and

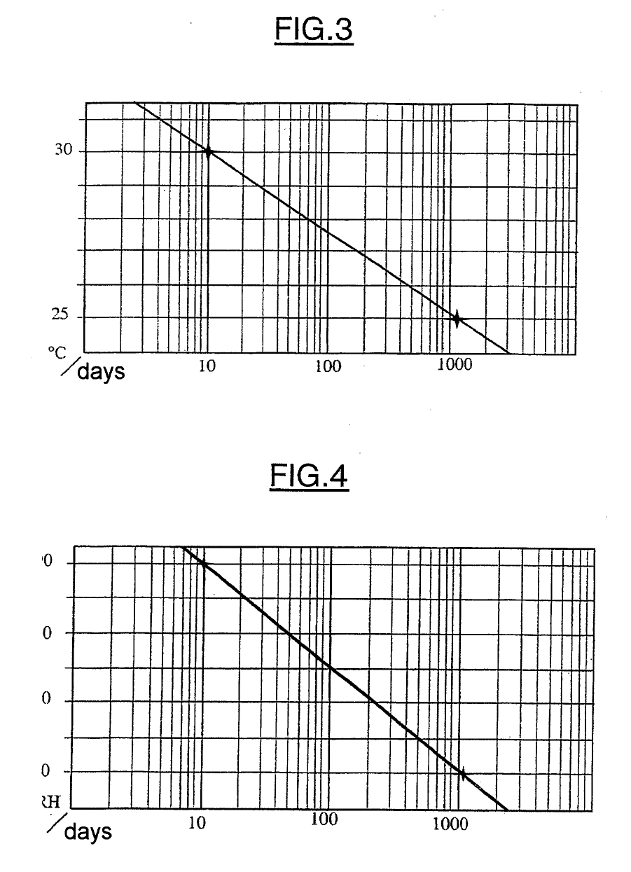

FIGS. 3 and 4 are curves illustrating an example of temperature and humidity threshold values stored in the system according to the invention;

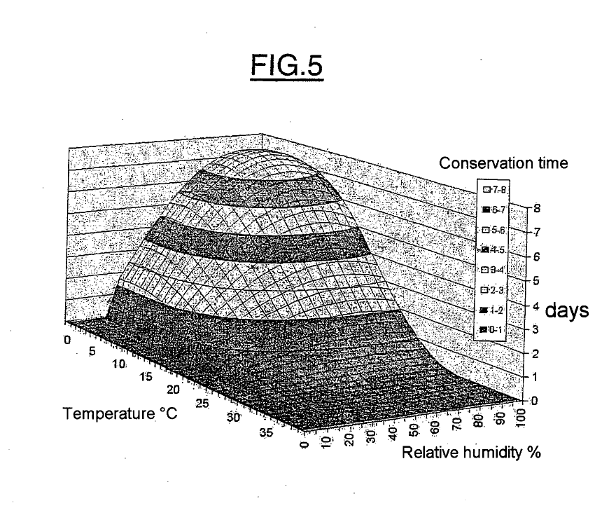

FIG. 5 illustrates the development over time of the temperature and humidity levels recorded by means of the system according to the invention; and

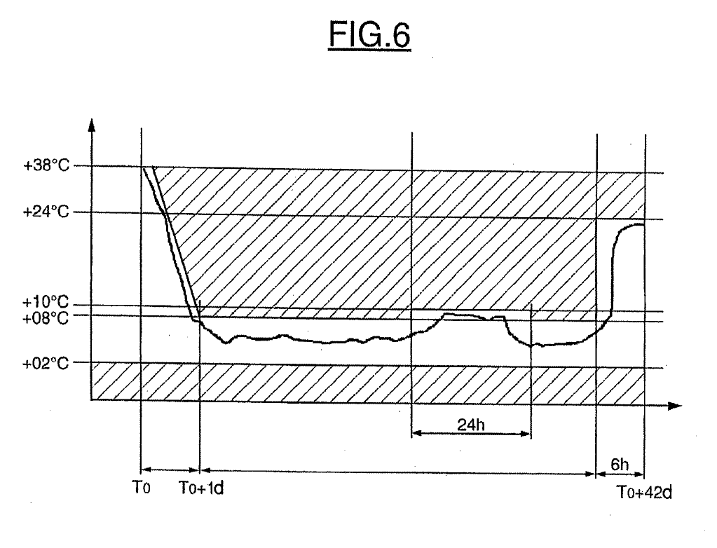

FIG. 6 is a curve illustrating the development over time of the temperature of a bag of blood from blood-taking to transfusion.

FIG. 1 shows the general architecture of a product monitoring system according to the invention. This system is intended to implement product traceability, that is, to track the products at the various stages of their production, transformation, marketing or transportation, by observing the development over time of one or more product-related variables.

As can be seen from this FIG. 1, the system includes a set of plotters, such as 10, intended to be affixed to the products, and a set of transceivers, such as 12, intended to communicate with the plotters 10, in particular to retrieve the measurement data generated by the plotters.

The plotters 10 are primarily implemented in the form of a support, on which are implemented sensors or detectors for measuring the characteristic variables to be measured, storage means for storing the data output by the sensors, and processing means for analyzing the data output by the sensors. As can be seen, the nature and number of the variables to be monitored depends on the type of product for which the traceability is to be provided. Thus, for example, the detectors embedded on the plotters can be made up of temperature sensors, acceleration sensors, pressure sensors, etc. However, the measured variable can be any type of physical parameter of which any drift is liable to affect the product.

As will be described in detail later; the plotters 10 continuously, possibly periodically, acquire measurement data, this data then, after storage, being analyzed by the processing means embedded on the support to detect any overrun beyond one or more maximum permitted threshold values. It will be noted that, preferably, the data is stored at intervals such that the data is acquired in supernumerary fashion, so that, by subsequent analysis, acquisition anomalies can be detected.

During their transportation, when the products and the plotters 10 that they support reach a predetermined check point, the measurement data and the processing data is transferred to transceivers 12. A remote monitoring center equipped with a display station 14 is then used to remotely display the data and analyze it to generate history logs and identify and locate malfunctions in the product transportation chain.

For example, as can be seen from FIG. 1, the transceivers 12 are connected to a computer network, for example the Internet 16, or a local data network. In this case, a web server 18 is used to remotely manage the various elements of the monitoring system and to centralize the data output by the plotters 10.

For example, as can be seen from FIG. 1, the transceivers 12 can be associated with an intermediate processing station 20 to display the retrieved data on site or, as a variant, to communicate directly with the web server via a router 22.

There now follows a description with reference to FIG. 2 of the general structure of a plotter 10 used to measure, store and analyze a physical variable related to a product to be monitored.

As indicated previously, such a plotter 10 primarily comprises a support 20 in generally parallelogram form, the dimensions of which can be, for example, around 10 cm×5 cm, for a maximum thickness of around 5 mm. Such a plotter 10 is designed to be fixed to a product for which the traceability is to be provided, by gluing, for example.

As indicated previously, it includes a set of sensors, such as 26, each measuring a physical variable of the product for which a drift is liable to affect the integrity or conservation.

The data output by the sensors 26 is supplied to a metrological conversion and calibration unit 28 for adjusting the data output by the sensors according to calibration curves supplied by the sensor manufacturers.

After preprocessing, the measurement data is stored in a storage unit 30 under the control of a management device 32 embedded on the plotter 10.

In practice, according to a characteristic of the invention, the storage unit 30 takes the form of a file system, that is, a set of files for which data storage and retrieval is performed in an organized way under the control of the file manager 32, the nature of the information to be logged not affecting the rules governing the organization of the storage medium. Thus, according to such a system, the storage space is divided into a number of individually identifiable subsets, the size of the individual elements stored not being a factor in the data storage rules.

The acquisition and the storage of the data in the file system are performed independently, through the use of different clocks for data acquisition on the one hand, and data storage on the other hand. In particular, the measurement period is independent of the data logging period. It is thus possible, for example, to adapt the flow of data to be stored in the file system according to the speed at which the monitored variables vary. Thus, the size of the storage means used is reduced, which is not the case in a plotter in which the data storage is performed according to the acquisition period. The data processing and transmission times for subsequent retrieval are also considerably reduced.

The file system is divided into four memory areas, namely one area of fixed size and three areas of variable size, defined using a programming tool.

The first fixed-size area is intended to contain programming data for the plotter 10.

The second area, of variable size, contains the user data, in particular computer files with standard extension, compressed or otherwise.

The third area is a buffer storage area in which are logged the measurements for a logging period and only for that period. The type of measurements stored in this third area is chosen during programming, and in particular, based on data taken from the first storage area. Thus, in the third area, it is possible to store only minimum, maximum, average, integral, decibel, weighted, raw or filtered, and other values.

Finally, the fourth area constitutes a final storage area in which is stored the data from the third area. This record is normally on 16 bits.

At the end of the logging period, a value associated with a time is logged.

Thus, the file system manages the sequencing of the data in the storage means, the data type and, generally, the procedure for storing the data based on programming data previously established by the user and based on data stored in a buffer memory. Furthermore, the file system manages the data originating externally in a second memory area, providing for dynamic modification and, possibly, remote modification, of the user data, such as threshold values, according to particular circumstances.

The plotter 10 is moreover provided with a computation unit 34, for actually observing the development of the variables monitored and stored. This computation unit 34 is coupled to a universal internal clock (not shown), for monitoring the development of the monitored variables according to timetable criteria. As will be described in detail later, it is then possible to create monitoring phases during each of which specific maximum thresholds are provided.

A display unit 36, preferably implemented using light-emitting diodes, is used to provide an indication as to the development of the monitored variable(s) in relation to the threshold values.

Furthermore, a battery 38 associated with a power converter 40 powers the main elements involved in the plotter 10. In particular, the power converter 40 provides a voltage step-up function for powering the light-emitting diodes used in the display unit 36, from the battery 38.

Finally, the plotter 10 is complemented with transmission and reception means providing for wireless data transmission between the plotter 10 and the transceivers of the remote monitoring system. It will be noted that the wireless communication used for the data transfer can be based on any type of telecommunications technique appropriate for the planned use. As an example, the following technologies can be used: IRP, IRDA, RF 13.56, 433, 868, 915, Bluetooth, Wi-Fi. However, any other technology can also be considered, according to operating requirements.

As can be seen in FIG. 2, these transmission and reception means include, on the one hand, a transmitter 42 associated with a file encryption module 44 and, on-the other hand, a receiver 46 associated with a file decoding module 48, the transmitter 42 and the receiver 46 being connected to an antenna 50 for communicating with a corresponding antenna of the transceiver 12 of the remote monitoring system.

The system that has just been described operates as follows:

For product traceability purposes, the plotter 10 associated with this product, constantly, for example periodically, acquires measurement data for a variable to be monitored. This data is calibrated and processed by the file manager 32, then stored in the storage unit 30. Moreover, the computation unit 34, for each data item acquired, performs a comparison with one or more predetermined threshold values so as to detect any overrun that could affect the good conservation of the product.

As indicated previously, the computation unit 34 adapts the threshold values according to monitoring phases.

Thus, for example, for a plotter intended for the agri-foodstuffs or pharmaceuticals market, for monitoring the development over time of the temperature and relative humidity of a product, the plotter is provided with two sensors, namely a temperature sensor and a humidity sensor.

For example, the limiting temperature and humidity values are given by the curves illustrated in FIGS. 3 and 4. Thus, the limiting temperature values not to be overrun for a product to be protected are 25° C. with a relative humidity of 60% for 3 years and 30° C. with a relative humidity of 60% for 10 days. Regarding humidity, these values are 60% relative humidity at 25° C. for 3 years and 90% relative humidity at 25° C. for 10 days.

As can be seen in FIG. 5, embedding a management algorithm in the plotters makes it possible to create a three-dimensional function from the measured variables. Such operation is based on Arrhenius's and/or Eyring's laws. The system also retains irreversible triggering thresholds.

Thus, as can be seen from FIG. 5, it is possible to create a three-dimensional graph linking temperature and relative humidity levels as a function of time and so enabling any study of stability of the monitored product to be implemented easily, inasmuch as the program for implementing these stability studies is incorporated in each plotter.

Referring to figure 6, for a bag of blood, during a first phase between T0 and T0+1 day, which is the blood-taking phase, the temperature must be lowered fairly evenly from approximately +37° C. to approximately +7° C. During the second phase, which extends to the time T0+42 days, the duly filled bag is conserved and transported to the place of use. The third phase, which lasts approximately 6 hours, is an actual transfusion phase.

Thus, during the first phase, that is, the blood-taking phase, the blood temperature must drop evenly to a temperature of around approximately 7° C.

In the second phase, that is, during its conservation, the temperature of the blood must not exceed 8° C. However, during the actual transportation phase, which is a relatively short phase, around 24 hours, a fairly low temperature rise is allowed, to a temperature of around 10° C. Finally, the transfusion phase must not take place at a temperature greater than approximately 24° C.

Thus, the computation unit 34 uses the universal internal clock to determine the current phase of the product and then generates the thresholds that are not to be exceeded.

If an overrun is detected, corresponding information is stored in the file system 30.

At the same time, the display unit 36 is driven to provide an indication of such an overrun.

Thus, for example, if there is no overrun, the display unit 36 is driven to output a blinking green light. Conversely, when an overrun is detected, the display unit 36 is driven to output a blinking red light so indicating that the product is no longer fit for consumption or use. Naturally, as will be understood, the transition from a blinking green light to a blinking red light is irreversible.

Finally, when the plotter 10, during its transportation, passes in front of a transceiver 12, the stored information is downloaded so that it can then be transmitted to the web server 18. It is thus possible to display, in a central and remote manner, the position of all of the products monitored and have available all of the information representative of the development of a monitored parameter.

Naturally, the data transfer between the plotter and the transceivers is bidirectional, with information being able to be transmitted automatically to the plotters when they pass in front of such transceivers. Thus, for example, when taking blood, all of the information concerning the donor, such as name, blood group, rhesus sign, etc., is entered in the file system, this information then being easy to retrieve when the bag passes in front of a transceiver at the place of transfusion.

It will be noted that, preferably, the plotters can also be linked to barcode-type encoding means for storing information redundantly, such that this information can be retrieved even when there are no means available for setting up a communication with the plotters.

1. A device for acquiring and monitoring over time the development of at least one product-related variable, including a support intended to be associated with the product and supporting a set of at least one sensor for measuring said variable and means for processing the data output by the sensor so as to monitor the development of said variable relative to threshold values, wherein the processing means include a file system in which the data output by the sensor is stored and a management algorithm for organizing the storing of the data in the file system and managing the retrieval of said data, the file system and the management algorithm being embedded in the support.

2. The device as claimed in claim 1, wherein it includes a universal internal clock, the processing means monitoring the development over time of said variable according to timetable data supplied by the clock.

3. The device as claimed in claim 2, wherein the processing means include means for creating product monitoring monitoring phases, each corresponding to a state of the product, by assigning specific threshold and duration values to each phase.

4. The device as claimed in claim 1, wherein it includes a display unit for indicating any overrun of the or each threshold value(s).

5. The device as claimed in claim 4, wherein the display unit is a blinking indicator, the color of which reflects a criterion for acceptance of a signaled overrun.

6. The device as claimed in claim 5, characterized in that wherein the blinking indicator comprises a light-emitting diode.

7. The device as claimed in claim 6, wherein it includes an independent power supply battery and voltage step-up means for powering the light-emitting diode.

8. The device as claimed in claim 1, wherein it includes means for transferring the stored data to a remote product monitoring system, in response to a request to transfer said data sent by said system.

9. The device as claimed in claim 8, characterized in that wherein the means for transferring the data are wireless data transfer means.

10. The device as claimed in claim 1 wherein the support also includes means of encoding information by bar odes.

11. A system for monitoring products by observing the development over time of at least one product-related variable, including a set of sensors for measuring said variable and a remote monitoring center for displaying the data output by the sensors, wherein the sensors consist of devices according to claim 1.

12. The system as claimed in claim 11, characterized in wherein the remote monitoring center is connected to a computer network, in particular the Internet.
a plurality of laser irradiation section by which laser beams with such a wavelength as to have a vasodilating action are radiated as pulses from positions over a skin;
a holding section for positioning and fixing laser beam outgoing ports of said plurality of laser irradiation section in a radial pattern so that said laser beams are concentrated onto a subcutaneous target part; and
a control section for such a control that laser irradiations by said plurality of laser irradiation section are conducted at time intervals.
